(19) United States
(12) Patent Application Publication
(10) Pub. No.: US 2026/0189304 A1
(43) Pub. Date: Jul. 2, 2026

(54) APPARATUS FOR GENERATING OPTICAL PULSE UTILIZING OPTICAL WAVEGUIDE DISPERSION AND METHOD THEREOF

(71) Applicant: KOREA ADVANCED INSTITUTE OF SCIENCE AND TECHNOLOGY, Daejeon (KR)

(72) Inventors: Kyoungsik YU, Daejeon (KR); Sangjoon PARK, Daejeon (KR); Yongbeom KIM, Daejeon (KR); Chanhyeok LEE, Daejeon (KR)

(21) Appl. No.: 19/434,377

(22) Filed: Dec. 29, 2025

(30) Foreign Application Priority Data
Dec. 30, 2024 (KR) 10-2024-0199735
Dec. 30, 2024 (KR) 10-2024-0199736
Dec. 15, 2025 (KR) 10-2025-0199388

(51) Int. Cl. H04B 10/508; G02F 1/035; H04B 10/50; H04B 10/548

(52) U.S. Cl. CPC H04B 10/508; G02F 1/035; H04B 10/503; H04B 10/548

(57) ABSTRACT

An optical pulse generating apparatus utilizing optical waveguide dispersion and a method thereof are disclosed. This apparatus includes a sine wave generator generating one of a plurality of sine waves and a phase modulator modulating incident light from a laser using the sine wave generated by the sine wave generator. This apparatus further includes a phase controller that controls the sine wave generator to generate one sine wave by transmitting sine wave information used in generation of an optical pulse selected by a user, and controls an optical waveguide connected to a phase modulator by transmitting optical waveguide information used in generation of the optical pulse to the optical waveguide connector. The sine wave information includes frequency information and amplitude information (or modulation index information) for generation of an optical pulse, and the optical waveguide information includes length information (or dispersion value information) for generation of an optical pulse.

### CROSS-REFERENCE TO RELATED APPLICATION

This application claims priority to and the benefit of Korean Patent Application No. 10-2024-0199735 filed with the Korean Intellectual Property Office on Dec. 30, 2024, Korean Patent Application No. 10-2025-0199388 filed with the Korean Intellectual Property Office on Dec. 15, 2025, and Korean Patent Application No. 10-2024-0199736 filed with the Korean Intellectual Property Office on Dec. 30, 2024, the entire contents of which are incorporated herein by reference.

### BACKGROUND OF THE INVENTION

### (a) Field of the Invention

The present invention relates to an optical pulse generating apparatus utilizing optical waveguide dispersion, and a method thereof.

### (b) Description of the Related Art

Currently, it is possible to generate a sine wave up to about 20 GHz to 40 GHz by an electrical method, but this is an insufficient frequency to be utilized for ultra-high-speed communication. The frequency may be further increased by utilizing a frequency doubler, which is a radio frequency (RF) device, but this method has a problem of a bandwidth limit of the frequency doubler.

As such, as a light is reached in electrically generating a high-frequency sine wave, an optical approach for generating a high-frequency sine wave is being researched. Representatively, frequency doubling and tripling generation systems utilizing a dual-parallel Mach-Zehnder modulator are being attempted.

In addition, there are two types of pulses representatively used in optical communication: a non-return to zero (NRZ) pulse and a return to zero (RZ) pulse. The NRZ pulse has an advantage that generation is simple and a required bandwidth is lower compared to the RZ pulse, but it is vulnerable to signal distortion called inter-symbol interference (ISI), and clock recovery is also not as easy as compared to the RZ pulse. In addition, since the NRZ pulse has higher pulse power per period compared to the RZ pulse, there is a disadvantage that it is much more vulnerable than the RZ pulse when utilized for long-distance communication.

Therefore, it is advantageous to utilize the RZ pulse whether it is short-distance high-speed communication using light or long-distance communication. Representatively, three types of RZ pulses exist: RZ 33%, RZ 50%, and RZ 67%. Here, the numbers after RZ mean a duty cycle.

In order to generate such an RZ pulse by an optical method, a Mach-Zehnder modulator is usually utilized, and the RZ pulse is generated by injecting a sine wave having an appropriate bias and an appropriate amplitude into the Mach-Zehnder modulator.

However, the Mach-Zehnder modulator has a large optical loss, and in the case of a lithium modulator used here, additional consideration is required due to a bias drift effect, and also, in the case of a silicon modulator, there is a problem that frequency doubling and tripling conditions or RZ pulse generation conditions become complicated because a relationship between phase and voltage is non-linear.

### SUMMARY OF THE INVENTION

The task that the present invention aims to solve is to provide an optical pulse generating apparatus that utilizes optical waveguide dispersion capable of generating n-multiplied sine wave, an RZ pulse, and a sinc pulse using a sime structure, and a method thereof.

In order to achieve the tasks of the present invention as described above and to realize the characteristic effects of the present invention described below, the characteristic composition of the present invention is as follows.

According to one aspect of the present invention, an optical pulse generating apparatus is provided.

The optical pulse generating apparatus includes: a sine wave generator that generates one of a plurality of sine waves; a phase modulator that performs modulation for incident light from a laser using the sine wave generated by the sine wave generator; an optical waveguide connector that connects an optical waveguide to the phase modulator-when the number of optical waveguides is two or more, one of two or more optical waveguides is selected and connected to the phase modulator-; and a pulse controller that generates the one sine wave by transmitting sine wave information, used in generation of an optical pulse selected by a user, to the sine wave generator, and transmits optical waveguide information used in generation of the optical pulse to the optical waveguide connector to select the optical waveguide connected to the phase modulator, wherein the sine wave information includes frequency information and amplitude information (or modulation index information) for generation of the optical pulse, and the optical waveguide information includes length information (or dispersion value information) for generation of the optical pulse.

Here, the pulse controller may include: a storage portion that stores sine wave information and optical waveguide information corresponding to each optical pulse; a selection controller that obtains sine wave information and optical waveguide information corresponding to an optical pulse selected by a user input through a user interface from the storage portion; a sine wave controller that controls the sine wave generator to generate a sine wave corresponding to the sine wave information obtained by the selection controller; and an optical waveguide controller that controls the optical waveguide connector to select an optical waveguide corresponding to the optical waveguide information obtained by the selection controller.

In addition, when the optical pulse selected by the user is an n-multiplied pulse (n is a natural number from 1 to 5), the optical waveguide information is determined as a dispersion value when a specific order harmonic component among 0-th order harmonic component to fifth-order harmonic component of the optical pulse output through the optical waveguide connected to the phase modulator according to the sine wave information is at a maximum, and all of the remaining harmonic components or all remaining harmonic components except at lease one is 0, and the n-multiplied pulse is a multiplied pulse of the specific order.

In addition, when the optical pulse selected by the user is a tripled pulse, the optical waveguide information is determined as a dispersion value when the magnitude of a third-order harmonic component of an optical pulse output through the optical waveguide becomes at its' a maximum and the magnitudes of first-order harmonic component, second-order harmonic component, and fourth-order harmonic component of the optical pulse are zero.

In addition, when the optical pulse selected by the user is a tripled pulse, a low pass filter is used to remove a fifth-order harmonic component of the optical pulse output through the optical waveguide from the determined dispersion value.

In addition, when the optical pulse selected by the user is a return to zero (RZ) pulse, the optical waveguide information is determined as a dispersion value of a case in which a magnitude ratio of a carrier of an optical pulse output through an optical waveguide connected to the phase modulator according to the sine wave information and a first-order harmonic component is similar to a magnitude ratio of a carrier and a first-order harmonic component of an RZ 50% pulse within a predetermined difference range.

In addition, when the optical pulse selected by the user is a return to zero (RZ) pulse, the optical waveguide information is determined as a dispersion value of a case in which magnitude ratios of a carrier, a second-order harmonic component, and a fourth-order harmonic component of an optical pulse output through an optical waveguide connected to the phase modulator according to the sine wave information is similar to magnitude ratios of a carrier, a second-order harmonic component, and a fourth-order harmonic component of an RZ 33% pulse is within a predetermined difference range.

In addition, when the optical pulse selected by the user is a sinc pulse of which a pulse width is narrow to be usable in an optical time division multiplexing (OTDM), the optical waveguide is determined as a dispersion value of a case in which the magnitude of each of a first-order harmonic component, a second-order harmonic component, and a third-order harmonic component of an optical pulse output through an optical waveguide connected to the phase modulator according to the sine wave information is similar within a predetermined difference range.

In addition, even though a frequency of the sine wave is the same, a length of the optical waveguide changes depending on the amplitude of the sine wave, and even though the amplitude of the sine wave is the same, the length of the optical waveguide changes depending on the frequency of the sine wave.

In addition, the phase modulator is a lithium niobate (LiNbO₃) modulator.

In addition, the optical waveguide is a silicon optical waveguide implemented in a silicon photonics chip together with the optical waveguide connector.

In addition, the phase modulator is a silicon phase modulator implemented in the silicon photonics chip and connected to the optical waveguide connector.

According to another aspect of the present invention, an optical pulse generating method is provided.

As a method for generating an optical pulse by an optical pulse generating apparatus that includes a phase modulator that performs modulation on incident light from a laser using a sine wave and outputs the modulated light through an optical waveguide, the method includes: receiving an optical pulse selected to be generated from a user; obtaining sine wave information and optical waveguide information used in generation of the optical pulse selected by the user among a plurality of pieces of predetermined sine wave information and a plurality of pieces of predetermined optical waveguide information; connecting an optical waveguide corresponding to the optical waveguide information among at least one of optical waveguides to the phase modulator; and generating a corresponding sine wave according to the obtained sine wave information and providing the sine wave to the phase modulator, and the sine wave information includes frequency information and amplitude information (or modulation index information) for generation of the optical pulse, and the optical waveguide information includes length information (or dispersion value information) of an optical waveguide for generation of the optical pulse.

Here, when the optical pulse selected by the user is an n-multiplied pulse (n is a natural number from 1 to 5), the optical waveguide information is determined as a dispersion value when a specific order harmonic component among 0-th order harmonic component to fifth-order harmonic component of the optical pulse output through the optical waveguide connected to the phase modulator according to the sine wave information is at a maximum, and all the remaining harmonic components or all remaining harmonic components except at lease one is 0, and

In addition, when the optical pulse selected by the user is a tripled pulse, the optical waveguide information is determined as a dispersion value when the magnitude of a third-order harmonic component of an optical pulse output through the optical waveguide becomes at a maximum and the magnitudes of first-order harmonic component, second-order harmonic component, and fourth-order harmonic component of the optical pulse are zero.

When the optical pulse selected by the user is a return to zero (RZ) pulse, the optical waveguide information is determined as a dispersion value of a case in which a magnitude ratio of a carrier of an optical pulse output through an optical waveguide connected to the phase modulator according to the sine wave information and a first-order harmonic component is similar to a magnitude ratio of a carrier and a first-order harmonic component of an RZ 50% pulse within a predetermined difference range, and the RZ pulse is an RZ 50% pulse.

In addition, when the optical pulse selected by the user is a return to zero (RZ) pulse, the optical waveguide information is determined as a dispersion value of a case in which magnitude ratios of a carrier, a second-order harmonic component, and a fourth-order harmonic component of an optical pulse output through an optical waveguide connected to the phase modulator according to the sine wave information is similar to magnitude ratios of a carrier, a second-order harmonic component, and a fourth-order harmonic component of an RZ 33% pulse is within a predetermined difference range.

In addition, when the optical pulse selected by the user is a sinc pulse of which a pulse width is narrow to be usable in an optical time division multiplexing (OTDM), the optical waveguide information is determined as a dispersion value of a case in which the magnitude of each of a first-order harmonic component, a second-order harmonic component, and a third-order harmonic component of an optical pulse output through an optical waveguide connected to the phase modulator according to the sine wave information is similar within a predetermined difference range.

In addition, the phase modulator is a silicon phase modulator, and the phase modulator is implemented in a silicon photonics chip together with the optical waveguide connector and the optical waveguide.

According to the present invention, n-multiplied sine wave, an RZ pulse, and a sinc pulse can be generated using a simple structure.

In addition, an optical pulse of high-frequency close to 150 GHz can be generated.

### BRIEF DESCRIPTION OF THE DRAWINGS

FIG. 1 is a schematic configuration block diagram of an optical pulse generating apparatus according to an embodiment of the present invention.

FIG. 2 is a detailed configuration block diagram of the pulse controller shown in FIG. 1.

FIG. 3 shows an amplitude and a phase spectrum of a light signal shown at an output end of a phase modulator shown in FIG. 1.

FIG. 4 shows relative intensity and normalized magnitude of electric power of an k-th harmonic component of a light signal output through the optical waveguide shown in FIG. 1 in a case that frequencies of the sine wave are 30 GHz, 40 GHz, and 50 GHz, respectively.

FIG. 5 shows relative intensity of electric power of the k-th harmonic component of the light output through the optical waveguide shown in FIG. 1 in a case that the modulation indices are 1.2 and 0.7.

FIG. 6 shows relative intensity of electric power of the k-th harmonic component of the light output through the optical waveguide shown in FIG. 1 in a case that a frequency is 13.5 GHz, a modulation index is 0.61 π, and a dispersion value is 437 ps².

FIG. 7 shows relative intensity of electric power of the k-th harmonic component of the light output through the optical waveguide shown in FIG. 1 in a case that a frequency is 12.5 GHz, a modulation index is 1.2 π, and a dispersion value is 437 ps².

FIG. 8 shows a pulse waveform of a light signal output through the optical waveguide shown in FIG. 1 in a case that lengths of the optical waveguide are 16 km, 15 km, and 10 km, respectively.

FIG. 9 shows another example of the optical pulse generating apparatus 100 according to the embodiment of the present invention.

FIG. 10 is a drawing that shows an additional heater implemented in the silicon optical waveguide of the optical pulse generating apparatus shown in FIG. 9.

FIG. 11 shows still another example of the optical pulse generating apparatus according to an embodiment of the present invention.

FIG. 12 shows a ratio of the k-th harmonic component of the light signal output through the optical waveguide shown in FIG. 1 in cases of an RZ 50% pulse and an RZ 33% pulse.

FIG. 13 shows a normalized magnitude of the k-th harmonic component of the light signal output through the optical waveguide shown in FIG. 1 in a case that a frequency is 40 GHz and a modulation index is 0.25.

FIG. 14 shows the normalized magnitude shown in FIG. 13 in a frequency domain and a time domain.

FIG. 15 shows a normalized magnitude of the k-th harmonic component of the light signal output through the optical waveguide shown in FIG. 1 in a case that a frequency is 40 GHz and a modulation index is 0.65 fr.

FIG. 16 shows the normalized magnitude shown in FIG. 15 in a frequency domain and a time domain.

FIG. 17 shows a since pulse usable in a typical OTDM system in a frequency domain and a time domain.

FIG. 18 shows a normalized magnitude of the k-th harmonic component of the light signal output through the optical waveguide shown in FIG. 1 in a case that a frequency is 50 GHz and a modulation index is 0.75 π.

FIG. 19 shows the normalized magnitude shown in FIG. 18 in a frequency domain and a time domain.

FIG. 20 shows an experimental setup configuration for verifying the feasibility of implementing a sinc pulse through an optical pulse generating apparatus according to an embodiment of the present invention.

FIG. 21 shows an experiment result through the experimental setup configuration shown in FIG. 20.

FIG. 22 shows an experiment result through the experimental setup configuration shown in FIG. 20.

FIG. 23 is a schematic flowchart of an optical pulse generating method according to an embodiment of the present invention.

FIG. 24 is a schematic flowchart of a method for calculating a length of the optical waveguide for generating an n-multiplied optical pulse in the optical pulse generating apparatus according to an embodiment of the present invention.

FIG. 25 is a schematic flowchart of a method for calculating a length of the optical waveguide for generating an pulse in the optical pulse generating apparatus according to an embodiment of the present invention.

FIG. 26 is a schematic flowchart of a method for calculating a length of the optical waveguide for generating an sinc pulse in the optical pulse generating apparatus according to an embodiment of the present invention.

### DETAILED DESCRIPTION OF THE EMBODIMENTS

Hereinafter, with reference to the accompanying drawing, an embodiment of the present disclosure is described in detail such that a person of ordinary skill in the technical field to which the present disclosure belongs can easily perform the present disclosure. However, the present disclosure may be implemented in many different forms and is not limited to the embodiments described herein. In addition, in order to clearly describe the present disclosure in the drawing, parts that are not related to the description are omitted, and similar reference numerals are attached to similar parts throughout the specification.

In the description, reference numerals and names are given for better understanding and ease of description, and devices are not necessarily limited to the reference numerals or names.

In addition, unless explicitly described to the contrary, the word “comprise”, and variations such as “comprises” or “comprising”, will be understood to imply the inclusion of stated elements but not the exclusion of any other elements. In addition, the terms “-er”, “-or”, and “module” described in the specification mean units for processing at least one function and operation, and can be implemented by hardware components or software components, and combinations thereof.

In the description, expressions described in the singular may be interpreted as either singular or plural, unless explicitly stated as “one” or “single”. Terms containing ordinal numbers, such as “first” and “second” may be used to describe various configurations, but the components are not limited by these terms. These terms may be used to distinguish one component from another.

In the flowchart described with reference to the drawing, the order of operations may be changed, several operations may be merged, some operations may be decomposed, and certain operations may not be performed.

Hereinafter, an optical pulse generating apparatus according to an embodiment of the present invention will be described.

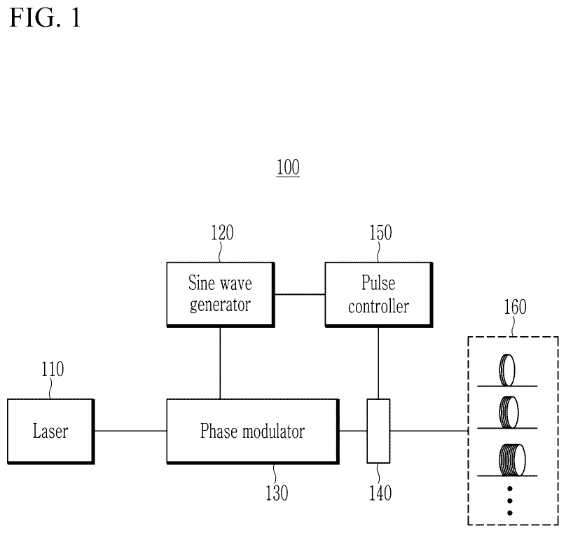

FIG. 1 is a schematic configuration block diagram of an optical pulse generating apparatus according to an embodiment of the present invention.

As shown in FIG. 1, an optical pulse generating apparatus 100 according to an embodiment of the present invention includes a laser 110, a sine wave generator 120, a phase modulator 130, an optical waveguide connector 140, and a pulse controller 150.

The laser 110 generates light of a single wavelength and provides the light to the phase modulator 120. That is, as a constituent element for generating light used in the phase modulator 120, a continuous wave (CW) laser may be used as the laser 110.

The sine wave generator 120 generates a sine wave corresponding to the control of the pulse controller 150 and provides the sine wave to the phase modulator 130.

The phase modulator 130 performs modulation for the light provided from the laser 110 using the sine wave provided from the sine wave generator 120 and output the modulation result.

The optical waveguide connector 140 connects one of at least one of optical waveguides 160 to the phase modulator 130 and outputs an optical pulse output from the phase modulator 130 to the outside. Here, the optical waveguide may be optical fiber, for example, a single mode optical fiber (SMF) or a silicon optical waveguide. In this case, where two or more optical waveguides are provided, the optical waveguide connector 140 selects one of the two or more optical waveguides 160 according to the control of the pulse controller 150 and connects the selected optical waveguide to the phase modulator 130. In this case, the optical waveguide connector 140 changes a position of at least one optical waveguide 160 using a position movement means such that the phase modulator 130 can be directly connected with the optical waveguide 160.

In order to generate an optical pulse selected by a user input, the pulse controller 150 controls the sine wave generator 120 to generate a necessary sine wave, and simultaneously, controls the optical waveguide connector 140 to select an optical waveguide. Here, as the optical pulse selected by the user input, n-multiplied optical pulses, for example, a double optical pulse and a triple optical pulse, a sinc pulse, a return-to-zero (RZ) 33% pulse, a RZ 50% pulse, and the like are included, but this is only an example and various other pulses may be selected.

Hereinafter, the above-described pulse controller 150 will be described in detail.

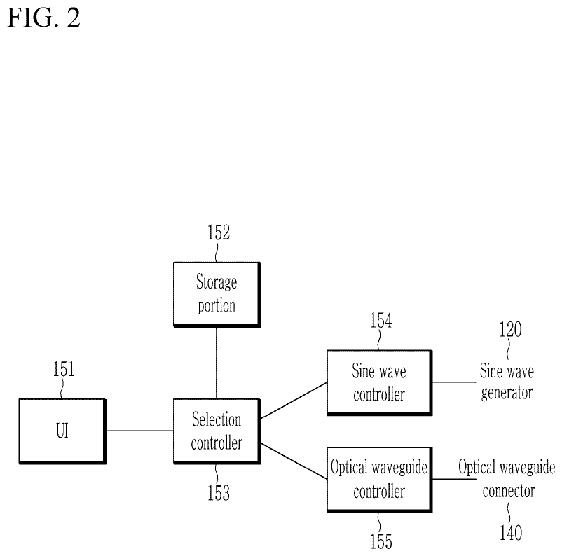

FIG. 2 is a detailed configuration block diagram of the pulse controller 150 shown in FIG. 1.

As shown in FIG. 2, the pulse controller 150 includes a user interface (UI) 151, a storage portion 152, a selection controller 153, a sine wave controller 154, and an optical waveguide controller 155.

The UI 151 is a constituent element for interaction with the user, and displays types of selectable optical pulses to the user and receives optical pulse information selected by the user among the displayed types of optical pulses.

The storage portion 152 stores sine wave generation information and optical waveguide information corresponding to each optical pulse that can be generated by the optical pulse generation apparatus 100 according to an embodiment of the present invention. Here, as the sine wave generation information, frequency information and amplitude information (or modulation index information) may be included.

After obtaining the sine wave generation information and the optical waveguide information for generation of the optical pulse selected by the user input through the UI 151, the selection controller 153 transmits the obtained sine wave generation information to the sine wave controller 154 and transmits the obtained optical waveguide information to the optical waveguide controller 155.

The sine wave controller 154 transmits the sine wave generation information transmitted from the selection controller 153 to the sine wave generator 120 and instructs to generate a corresponding sine wave.

The optical waveguide controller 155 transmits the optical waveguide information transmitted from the selection controller 153 to the optical waveguide connector 140 and instructs the connection of the corresponding optical waveguide to the phase modulator 130.

Hereinafter, a method for generating various optical pulses by the optical pulse generating apparatus 100 according to an embodiment of the present invention will be described.

First, a method for the optical pulse generating apparatus 100 to generate n-multiplied optical pulses will be described.

When assuming that an amplitude of light generated by the laser 110 of the optical pulse generating apparatus 100 according to the embodiment of the present invention and provided to the phase modulator 130 is E₀ and a frequency is ω₀, and an amplitude of a sine wave generated by the sine wave generator 120 and provided to the phase modulator 130 is A and a frequency is f_{RF}, a light signal E(t) phase-modulated by the phase modulator 130 and then output may be given as the following [Equation 1]. In this case, it is assumed that the phase modulator 130 has a linear voltage-phase relationship, and when a lithium-niobate (LiNbO₃) modulator is actually utilized, such an assumption is validated.

$$E ( t ) = {E}_{0} exp ( j {ω}_{0} t ) exp ( j m cos ( {ω}_{R F} t ) ) = {E}_{0} exp ( j {ω}_{0} t ) {\sum }_{n = - ∞}^{∞} {j}^{n} {J}_{n} ( m ) exp ( jn {ω}_{RF} t ) \qquad [ Equation 1 ]$$

Here, m denotes a modulation index of the phase modulator 130, which a measure of how much the phase can change when a voltage is injected into the phase modulator 130, and may ge represented as

$$m = π \frac{A}{{V}_{π}} .$$

In this case, V_{π} denotes a voltage required for π radian phase modulation.

Meanwhile, in [Equation 1],

$${\sum }_{n = - ∞}^{∞} {j}^{n} {J}_{n} ( m ) exp ( jn {ω}_{RF} t )$$

is an expression of exp(jmcos(ω_{RF}t)) in the form of a series sum utilizing the Jacobi-Anger expansion, and Jₙ(m) represents an n-th order Bessel function.

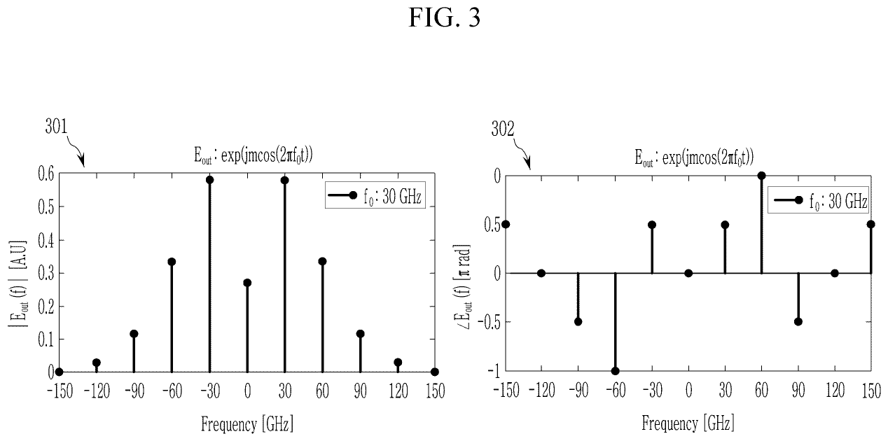

An amplitude 301 and a phase spectrum 302 of the light shown in an output end of the phase modulator 130, based on the above-described development are as shown in FIG. 3. The following assumptions apply when obtaining such a spectra:
1. The frequency of light itself generated by the laser 110 slightly affects the performance of the phase modulator 130, but does not have a decisive influence on the spectral result.
2. Therefore, assuming the phase modulator 130 operates in a wide wavelength band, only the frequency of the sine wave generated by the sine wave generator 120 is considered, without considering the frequency of the light.

Therefore, the above-described [Equation 1] may be represented as given in [Equation 2].

$$E ( t ) = {\sum }_{n = - ∞}^{∞} {j}^{n} {J}_{n} ( m ) exp ( jn {ω}_{RF} t ) \qquad [ Equation 2 ]$$

Meanwhile, when the light signal output from the phase modulator 130 passes through the optical waveguide 160, which is a dispersive medium, a channel characteristic needs to be considered. In the optical waveguide 160, for example, in an optical fiber, chromatic dispersion occurs. Such dispersion has liner characteristic, and assuming that additional nonliner phenomena and polarization mode dispersion (PMD) can be neglected, the optical waveguide 160 may be expressed as a frequency response such as the following [Equation 3].

$$H ( j ω ) = exp ( j \frac{1}{2} {β}_{2} L {ω}^{2} ) \qquad [ Equation 3 ]$$

Here, β₂ denotes a propagation factor, L denotes a length of the optical waveguide 160, and ω denotes each frequency.

Therefore, after the light signal which has output from the phase modulator 130 is passed through the optical waveguide 160 having the characteristic of [Equation 3], the light signal may be represented as given in [Equation 4].

$${E}_{2} ( t ) = {\sum }_{n = - ∞}^{∞} {j}^{n} {J}_{n} ( m ) exp ( jn {ω}_{RF} t ) exp ( j \frac{1}{2} {β}_{2} L {( n {ω}_{RF} )}^{2} ) \qquad [ Equation 4 ]$$

When the light signal passed through the optical waveguide 160 is detected through a photodetector (not shown) of which responsivity is 1, an electric power signal I(t) in this case is represented as E₂(t)·conj(E₂(t)). Here, electric power Iₖ(t) of the k-th harmonic component may be calculated as given in [Equation 5].

$${I}_{k} ( t ) = {\sum }_{n = - ∞}^{∞} {Γ}_{n + k} {Γ}_{n}^{*} \qquad [ Equation 5 ]$$

$${Γ}_{n} = {j}^{n} {J}_{n} ( m ) exp ( jn {ω}_{RF} t ) exp ( j \frac{1}{2} {β}_{2} L {( n {ω}_{RF} )}^{2} )$$

[Equation 5] may be developed as given in [Equation 6], and

$${I}_{k} ( t ) = {j}^{k} exp ( - j \frac{1}{2} {β}_{2} {L ( k {ω}_{RF} )}^{2} ) exp ( jk {ω}_{RF} t ) \times {\sum }_{n = - ∞}^{∞} {J}_{n + k} ( m ) {j}^{k} exp ( j {β}_{2} Lk ( n + k ) {ω}_{RF}^{2} ) \times \{ {J}_{n} ( m ) exp ( j 0 ) \} \qquad [ Equation 6 ]$$

to sum up this, the electric power Iₖ(t) of the k-th harmonic component may be simply represented as given in [Equation 7].

$${I}_{k} ( t ) = {( - 1 )}^{k} {J}_{k} [ 2 m sin ( \frac{1}{2} {β}_{2} Lk {ω}_{RF}^{2} ) ] exp ( jk {ω}_{RF} t ) \qquad [ Equation 7 ]$$

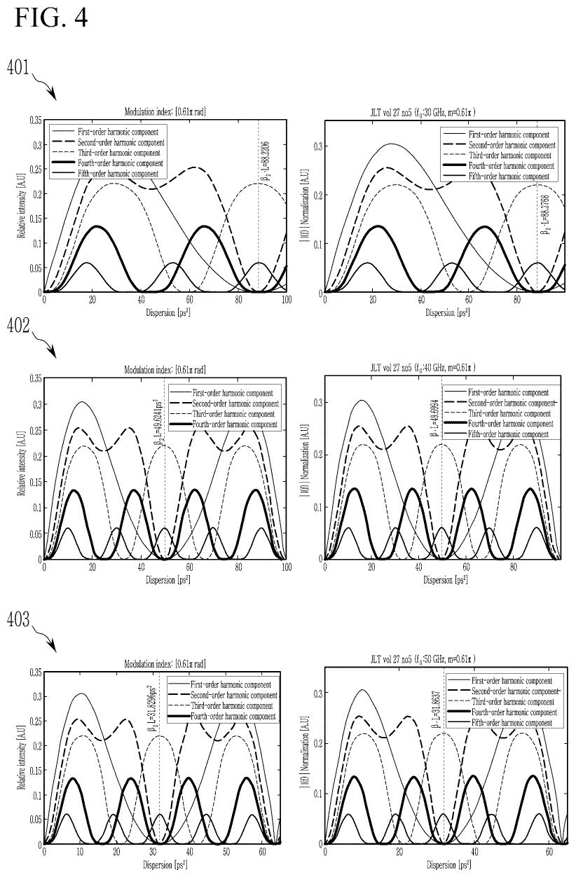

Through the above [Equation 7], it becomes possible to easily identify a change trend of the magnitude of the electric power Iₖ(t) of the k-th harmonic component according to the dispersion size. For example, it may be identified through the graphs 401, 402, and 403 shown in FIG. 4.

In FIG. 4, the graph 401 shows first to fifth order harmonic components for a sine wave of which a modulation index is 0.61π and a frequency is 30 GHz, the graph 402 shows first-order to fifth-order harmonic components for a sine wave of which a modulation index is a modulation index is 0.61 π and a frequency is 40 GHz, and the graph 403 shows first-order to fifth-order harmonic components for a sine wave of which a modulation index is 0.61π and a frequency is 50 GHz.

Among the graphs 401, 402, and 403, the graphs on the left side are results of directly calculating I(t) by utilizing fast Fourier transform (FFT) and represent magnitudes of first-order to fifth-order harmonic components according to a magnitude of dispersion, and the graphs on the right side may express the first to fifth order harmonic components by calculating them using the above-stated [Equation 7] which organizes these graphs.

For each graph (401, 402, and 403), the graphs on the left side and the graphs on the right side show among identical shapes, and the dispersion value representing a maximum value of the fifth-order harmonic component also appeared to be almost identical. Through this, it may be seen that the size component of the phase-modulated light signal that has passed through the optical waveguide 160 may be accurately represented.

Referring to the graphs 401, 402, and 403 of FIG. 4, it may be seen that when a light signal phase-modulated by a sine wave of 30 GHz, 40 GHz, and 50 GHz passes through the optical waveguide 160, which is a dispersion medium, there is a point where the magnitude of the third-order harmonic component becomes maximum and the magnitudes of the first-order, second-order, and third-order harmonic components becomes zero. Here, the prerequisite assumes that a sine wave having an amplitude greater than 0.5 V_{π} is injected.

The fifth-order harmonic component also reaches its maximum magnitude at the point where the third order harmonic component is maximized, but in the case of 30 GHz, 40 GHz, and 50 GHz, the frequencies of the fifth-order harmonic components correspond to about 150 GHz, 200 GHz, and 250 GHz, respectively. Therefore, when an appropriate optical detector suitable for a frequency tripler system is disposed considering the input sinusoidal frequency, the fifth-order harmonic components become negligible factors.

Therefore, when a sine wave having an appropriate amplitude is applied to the phase modulator 130 and a dispersion value at which the third-order harmonic component is maximized is applied, a sine wave having a frequency magnitude three times the original sinusoidal frequency may be obtained. Such a dispersion value may be adjusted by adjusting the length of the optical waveguide 160. In particular, referring to the graphs 401, 402, and 403 of FIG. 4, it may be seen that as the sinusoidal frequency input to the phase modulator 160 increases, the required dispersion value decreases, such as the dispersion value being 88.2206 ps² when the sinusoidal frequency having a modulation index of 0.61π (or amplitude of 0.61 π) is 30 GHz, the dispersion value being 49.6241 ps² when the sinusoidal frequency is 40 GHz, and the dispersion value being 31.8296 ps² when the sinusoidal frequency is 50 GHz.

As described above, in the optical pulse generating apparatus 100 according to an embodiment of the present invention, when the sine wave generator 120 provides a sine wave of 30 GHz to the phase modulator 130 and the optical waveguide 160 having a length such that the optical waveguide connector 140 has the dispersion value of 88.2206 ps², for example, an optical fiber, is connected to the phase modulator 130, an optical pulse of 90 GHz, which is three times the 30 GHz of the sine wave, will be detected through an optical detector (not shown) connected to an end of the optical waveguide 160. Similarly, in the case of a sine wave of 40 GHz and an optical waveguide 160 having a length with the dispersion value of 49.6241 ps², an optical pulse of 120 GHz, which is three times the sine wave of 40 GHz, is detected, and in the case of a sine wave of 50 GHz and an optical waveguide 160 having a length with the dispersion value of 31.8296 ps², an optical pulse of 150 GHz, which is three times the sine wave of 50 GHz, will be detected. In all of the above cases, the sine wave has a modulation index of 0.61 π or an amplitude of 0.61 V_{π}.

Therefore, in the optical pulse generation apparatus 100 according to an embodiment of the present invention, the sine wave generator 120 may generate sine waves of 30 GHz, 40 GHz, and 50 GHz having a modulation index of 0.61 V_{π} (or an amplitude of 0.61 V_{π}), and when at least one optical waveguide 160 is provided with three optical waveguides 160 having lengths corresponding to dispersion values of 88.2206 ps², 49.6241 ps², and 31.8296 ps², respectively, the pulse controller 150 causes one of the sine waves of 30 GHz, 40 GHz, and 50 GHz (this is also selectable by an input of the user) to be generated according to a user's input to generate a tripled optical pulse, and at the same time, performs control to select one of the three optical waveguides 160 having a length corresponding to one of the dispersion values, for example, 88.2206 ps², 49.6241 ps², and 31.8296 ps², corresponding to the selected sine wave, and connect the selected one to the phase modulator 130. Here, the user's input may be one of generating a triple optical pulse, specifically, generating a triple optical pulse (90 GHz) of 30 GHz, generating a triple optical pulse (120 GHz) of 40 GHz, or generating a triple optical pulse (150 GHz) of 50 GHz.

Meanwhile, as described above, the fifth-order harmonic component exists at the point where the third order harmonic component is maximized, and therefore, a photodetector (not shown) connected to a transmission end of the optical waveguide 160 is used as a low pass filter (LPF) for removing the fifth-order harmonic component and an actual LPF is added only when the LPF effect by the photodetector is insufficient such that a sine wave signal of almost pure triple frequency, which corresponds to three times the sinusoidal frequency may be obtained in the photodetector.

Meanwhile, in the above, only an example of generating an optical pulse having a triple frequency when the modulation index is 0.61 π has been described, but this principle may also be applied to other modulation indices of amplitudes.

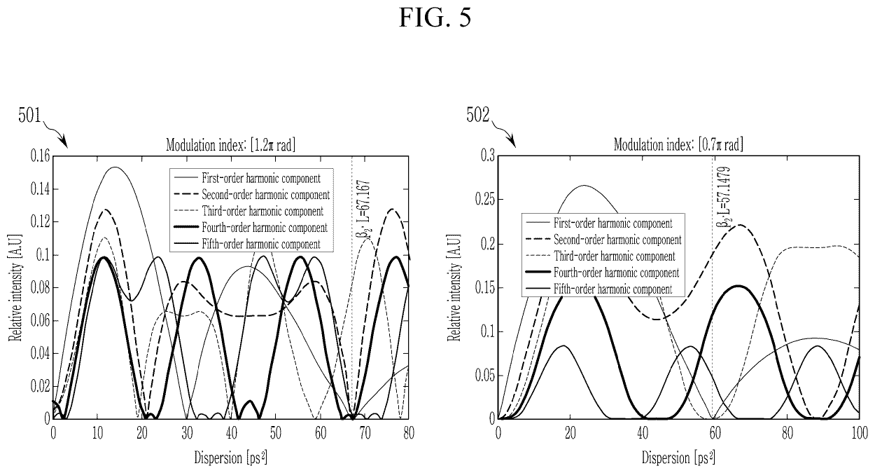

For example, referring to the graph 501 shown in FIG. 5, it may be seen that when the modulation index is 1.2 π, an optical pulse corresponding to a triple sine wave of an input sine wave may be generated by applying a dispersion value at which a third-order harmonic component is maximized, here, 67.167 ps². The graph 501 here corresponds to a case of a sine wave of 30 GHz.

In addition, referring to another graph 502 shown in FIG. 5, it may be seen that even when the modulation index is 0.7π, an optical pulse corresponding to a doubled sine wave of the input side wave may be generated by applying a dispersion value at which a second-order harmonic component is maximized, here, 59.1479 ps². The graph 502 here also corresponds to a case of a 30 GHz sine wave.

As such, according to the embodiment of the present embodiment, when a sine wave having a specific modulation index (or amplitude) is provided to the phase modulator 130 and the optical waveguide 160 having a length so as to have a dispersion value corresponding to the specific modulation index (or amplitude) is connected to the phase modulator 130, it is possible to generate an optical pulse of a sine wave of a multiple corresponding to the order of a harmonic component having a maximum value at the corresponding dispersion value (harmonic components of the remaining orders are zero or have a negligible size). In this case, for harmonic components of non-zero orders among the harmonic components of the remaining orders, an optical pulse of a multiplied frequency may be obtained by removing the harmonic components of the corresponding orders using a bandpass filter installed at a receiving side (or a photodetector side) (not shown) connected to the optical waveguide 160 to detect a light signal.

As an example, lengths of optical waveguides according to their types required based on a 30 GHz sine wave are shown in the following [Table 1]. [Table 1] shows lengths that enable generation of tripled frequency optical pulses.

TABLE 1

| | | RiB Si | SiN |
|---|---|---|---|
| Type of optical | | (slab: 90 nm) | 750 nm × |
| waveguide | SMF | 500 nm × 220 nm | 250 nm |
| Dispersion @1550 | 17 | 1300 | 1360 |
| nm (ps/nm/km) | | | |
| Length (m) | 4070 | 53 | 51 |

Hereinafter, a measurement performed for determining whether the optical pulse generating apparatus 100 according to the embodiment of the present invention actually generated n-multiplied optical pulses of a sine wave will be described.

First, as a device for measurement, the optical pulse generating apparatus 100 is configured as shown in FIG. 1, and a photodetector (not shown) is connected to a transmission end of the optical waveguide 160 to detect a light signal output through the optical waveguide 160.

In addition, a frequency of a sine wave generated by the sine wave generator 120 is set to be 17 GHz or less, and an amplifier (not shown) and a low pass filter (not shown) are additionally installed after the sine wave generator 120 such that only amplitude of a sine wave of an original signal can be amplified.

In addition, an amplifier (not shown) and a band pass filter are additionally installed after the laser 110 such that a ripple generated from light output from the laser 110 may be removed.

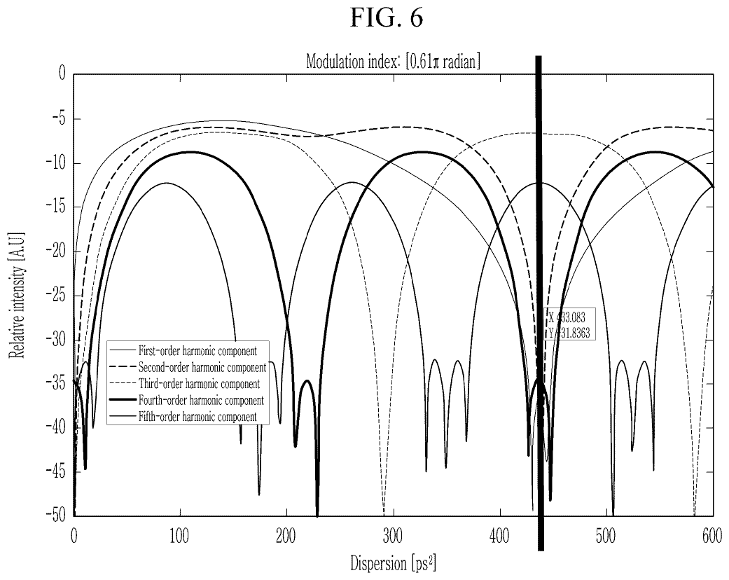

Firstly, as shown in FIG. 6, it was confirmed that a frequency-tripled optical pulse that is three times the frequency of a sine wave could be generated when measured by applying a sine wave having a frequency of 13.5 GHz and an amplitude such that the modulation index becomes 0.61π, and setting the length of an optical fiber that can achieve a dispersion value of 437 ps², for example, a single-mode fiber (SMF) having a chromatic dispersion diameter of 16 to 17 ps/nm/km, to 20 km.

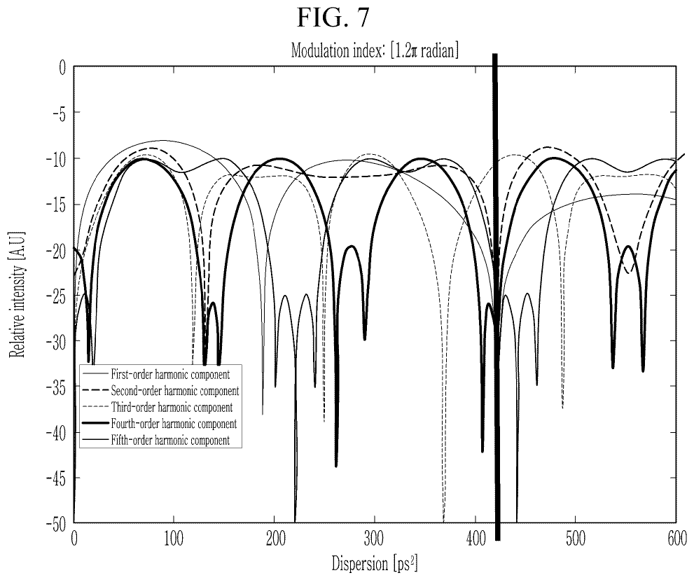

Secondly, as shown in FIG. 7, it was confirmed that a frequency-tripled optical pulse that is three times the frequency of a since wave could be generated when measured by applying a sine wave having a frequency of 12.5 GHz and an amplitude such that the modulation index becomes 1.2π, and setting the length of an optical fiber that can achieve a dispersion value of 437 ps², for example, an SMF having a chromatic dispersion diameter of 16 to 17 ps/nm/km, to 20 km.

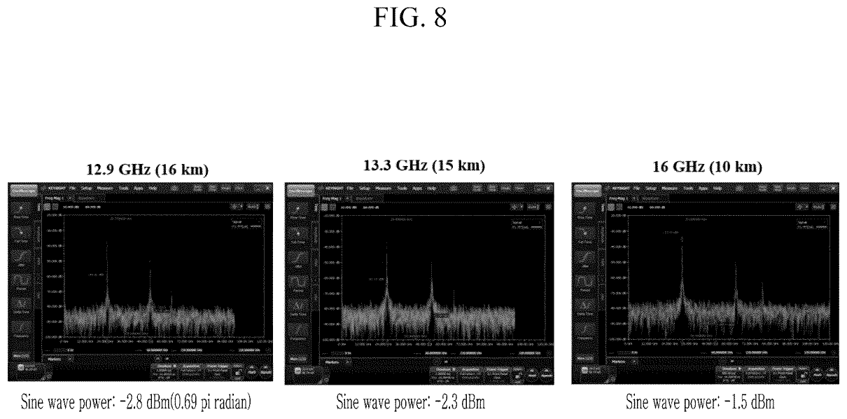

Thirdly, after setting the amplitude of the sine wave to correspond to a modulation index of 0.7π, spectra as shown in FIG. 8 were obtained when the lengths of the optical waveguide 160 were obtained when the lengths of the optical waveguide 160 were 16 km, 15 km, and 10 km, respectively such that it was confirmed that frequency doubling is also sufficiently possible.

Meanwhile, when an optical fiber is used as the optical waveguide 160, there is a disadvantage in that the length reaches several kilometers and the size increases. Therefore, in order to drastically reduce this, a silicon photonics integrated circuit may be utilized from the optical waveguide 160 to the photodetector (not shown).

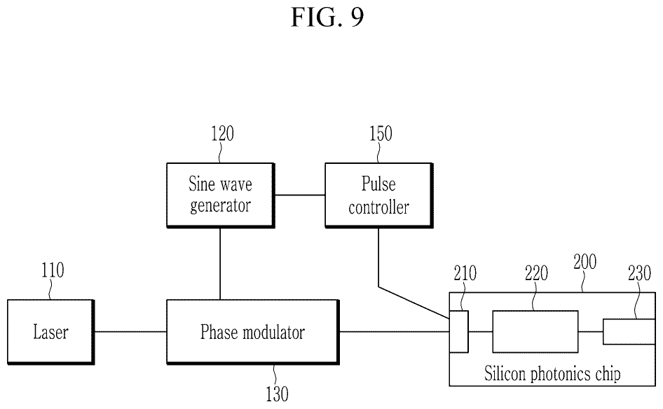

FIG. 9 shows another example of the optical pulse generating apparatus 100 according to the embodiment of the present invention.

Referring to FIG. 9, instead of the existing optical waveguide 160, a silicon optical waveguide 220 is configured inside a silicon photonics chip 200 together with the optical waveguide connector 210 and the photo detector 230.

Since the silicon optical waveguide 220 has a larger effective refractive index compared to the optical fiber, a dispersion value required to achieve double and triple frequency may be achieved even with a short length.

In addition, considering to reduce a loss due to side wall roughness occurring in the silicon optical waveguide 220 in the silicon photonics chip 200, the silicon optical waveguide 220 may be replaced with an optical waveguide form of an SiN material.

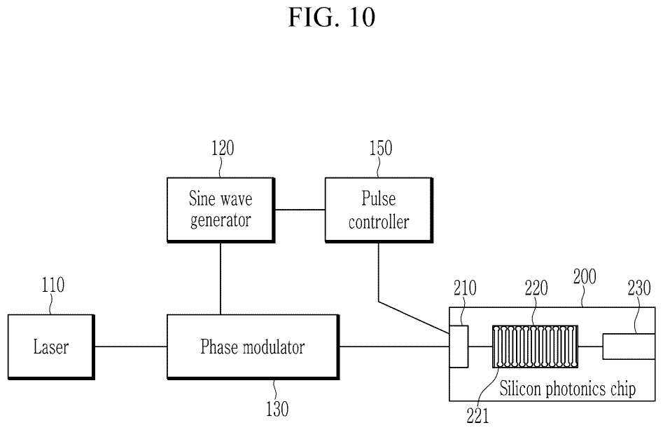

Meanwhile, since the dispersion magnitude for generating an n-multiplied frequency relative to an input sinusoidal frequency may vary in the silicon optical waveguide 220 in the silicon photonics chip 200 due to a process error, a heater 221 may be additionally provided to the silicon optical waveguide 220 to allow the dispersion to be adjusted as shown in FIG. 10.

Next, an example of implement the phase modulator 130 as a silicon photonics integrated circuit will be described.

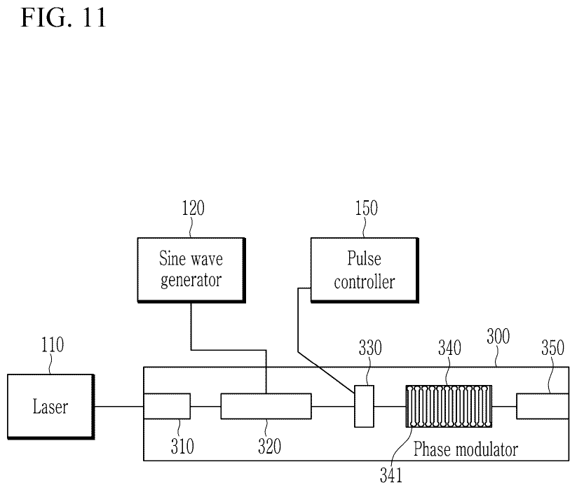

FIG. 11 shows still another example of the optical pulse generating apparatus 100 according to an embodiment of the present invention.

Referring to FIG. 11, instead of the existing phase modulator 130, a silicon phase modulator 320 is connected between an optical input device 310 and the optical waveguide connector 330 and is configured in the silicon photonics chip 300 together with the silicon optical waveguide 340 and the photo detector 350.

As such, the optical pulse generating apparatus 100 may be reduced in size by using the silicon phase modulator 320, which can be integrated into the silicon photonics chip 300 instead of using the lithium niobate (LiNbO₃), and a manufacturing process may also be simplified because most of the components can be integrated at once.

Similarly, since the dispersion magnitude for generating an n-multiplied frequency relative to the input sinusoidal frequency may vary in the silicon optical waveguide 340 in the silicon photonics chip 300 due to a process error, a heater 341 may be added to the silicon optical waveguide 340 to allow the dispersion to be adjusted.

Next, a method in which the optical pulse generating apparatus 100 according to an embodiment of the present invention generates an RZ pulse, for example, an optical pulse such as RZ 33%, RZ 50%, and the like will be described.

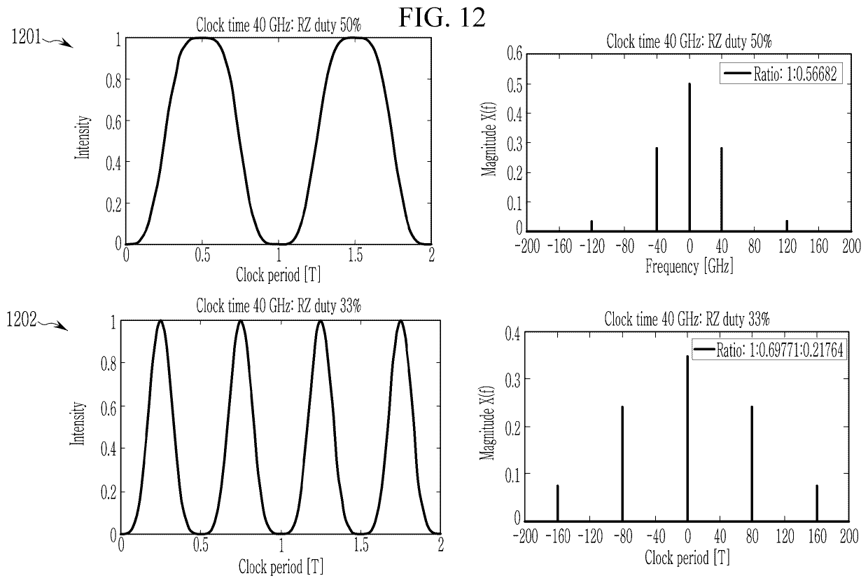

First, shapes of pulses during two cycles of RZ 33% and RZ 50% with a clock frequency of 40 GHz and ratios of harmonic components when these are converted into a frequency domain are shown in FIG. 12.

Referring to FIG. 12, in a graph 1201, it may be seen that the RZ 50% pulse shows a ratio of a carrier and a first-order harmonic component as 1:0.56682, and in a graph 1202, it may be seen that the RZ 33% pulse shows a ratio of a carrier, a second-order harmonic component, and a fourth-order harmonic component is respectively 1:0.69771:0.21764.

Meanwhile, it has already been described that when a light signal passed through the optical waveguide 160 is detected through a photo detector (not shown) having a responsivity of 1, the electric power Iₖ(t) of the k-th order harmonic component can be calculated as in the above-stated [Equation 7].

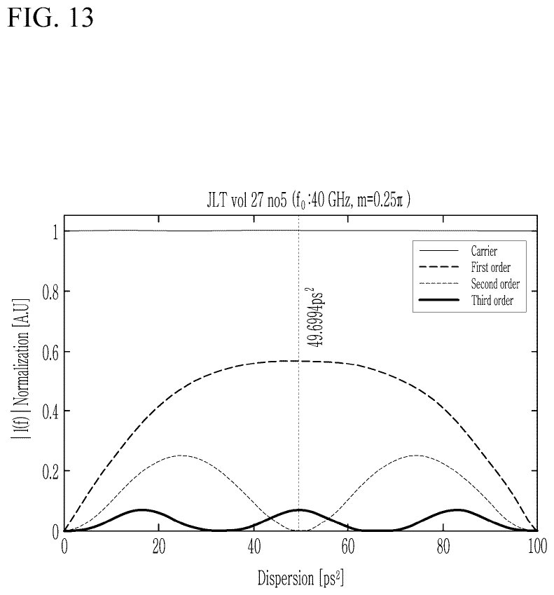

Using [Equation 7], when the input sinusoidal frequency is 40 GHz and the modulation index is 0.25π, the 0-th order (carrier), first-order, second-order, and third-order harmonic components of Iₖ(t) according to the magnitude of dispersion may be expressed as shown in FIG. 13.

In the case of the RZ 50% pulse, the ratio of the carrier and the first-order harmonic component is important. Referring to FIG. 13, it may be seen that when the modulation index is 0.25π, the ratio of the carrier and the first-order harmonic component is similar to 1:0.566 at a point where the dispersion value is 49.699 ps². Here, being similar may include a case where the ratio of the carrier and the first-order harmonic component is identical to 1:0.566 or where a difference from the ratio of 1:0.566 is within a difference of a predetermined threshold value (which may be expressed in %).

However, as shown in FIG. 13, although the magnitude of the third-order harmonic component appears at the dispersion value of 49.699 ps², it may be seen that when m=0.25π and the dispersion value of 49.699 ps² are applied, an I(t) aspect in a frequency domain 1401 and a time domain 1402 is generated in a shape almost similar to the ideal RZ 50% pulse shown in the graph 1201 shown in FIG. 12, and in this case, it can be seen that there is no influence if the magnitude of the third-order harmonic component is not large.

Therefore, when the length of the optical waveguide 160 is set such that the input sinusoidal frequency is 40 GHz, the modulation index is 0.25π, and the dispersion value is 49.699 ps², it can be seen that the optical pulse output through the optical waveguide 160 of the optical pulse generating apparatus 100 according to the embodiment of the present invention is similar to the RZ 50% pulse.

As an example, when the input sinusoidal frequency is 40 GHz, lengths according to types of optical waveguides 160 for generating the RZ 50% pulse are as shown in the following [Table 2].

TABLE 2

| | | SiB Si | SiN |
|---|---|---|---|
| Type of optical | | (Slab: 90 nm) | 750 nm × |
| waveguide | SMF | 500 nm × 220 nm | 250 nm |
| Dispersion @1550 | 17 | 1300 | 1360 |
| nm (ps/nm/km) | | | |
| Length (m) (RZ 50%) | 2293 | 30 | 28.6 |
| (40 GHz: 49.7 ps²) | | | |

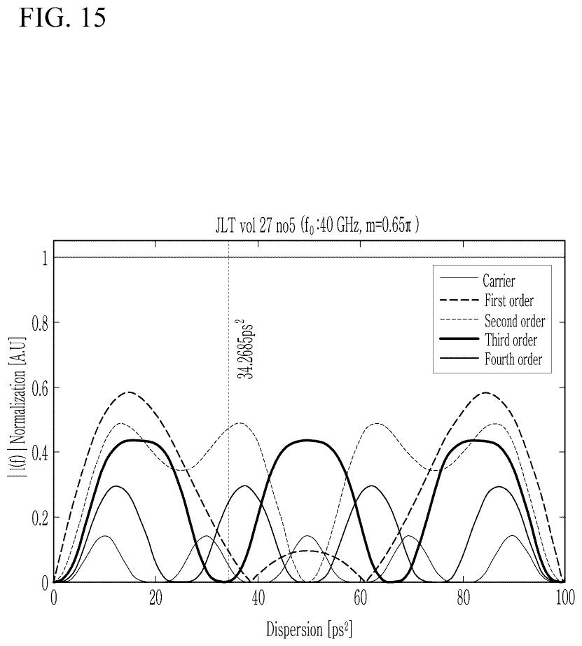

Similarly, in the case of the RZ 33% pulse, 0th-order (carrier), first-order, second-order, third-order, and fourth-order harmonic components of Iₖ(t) according to the magnitude of dispersion when the input sinusoidal frequency is 40 GHz and the modulation index is 0.65π using [Equation 7] may be expressed as shown in FIG. 15.

Unlike the RZ 50% pulse described above, for the RZ 33% pulse, ratios of the carrier, second-order, and fourth-order harmonic components are important, and in the case of the first-order harmonic component, it may be seen through the graph 1202 of FIG. 12 that the closer the magnitude is to 0, the better. Therefore, it may be confirmed that the modulation index and the dispersion value are 0.65 π and 34.268 ps², respectively, where the modulation index m is increased to be greater than 0.5 π to suppress the first-order harmonic component as much as possible, and the ratios of the carrier, second-order, and fourth-order harmonic components show an aspect similar to the ratio of the aforementioned RZ 33%, that is, 1:0.69771:0.21764. Here, the similar aspect may include a case where the ratios of the carrier, second-order harmonic component, and fourth-order harmonic component are the same as 1:0.69771:0.21764 or a difference from the ratio of 1:0.69771:0.21764 is within a difference of a preset threshold value (which can be expressed in %).

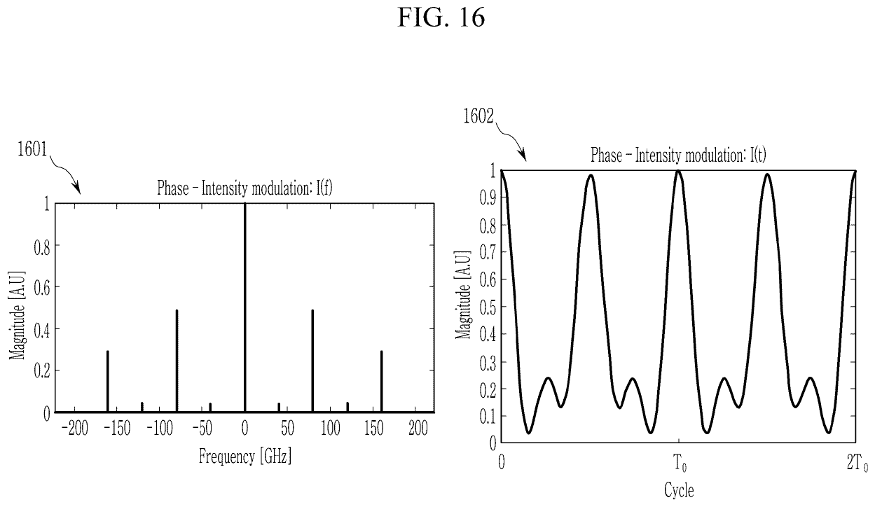

When m=0.65π and a dispersion value of 34.2685 ps² are applied in the same manner as the RZ 50% pulse, the I(t) aspect in the frequency domain 1601 and the time domain 1602 appears as shown in FIG. 16. Referring to FIG. 16, although frequency components of odd orders remain in the time domain, it may be seen that a shape similar to the ideal RZ 33% pulse shown in the graph 1202 shown in FIG. 12 is generated.

Therefore, when the length of the optical waveguide 160 is set such that the input sinusoidal frequency is 40 GHz, the modulation index is 0.65π, and the dispersion value is 34.2685 ps², it may be seen that the optical pulse output through the optical waveguide 160 of the optical pulse generating apparatus 100 according to the embodiment of the present invention is similar to the RZ 33% pulse.

The above-described example is an example where the frequency of the sine wave is 40 GHz, but even at a frequency lower or higher than this frequency, an RZ 50% pulse or an RZ 33% pulse could be generated at the corresponding frequency if the corresponding dispersion value is adjusted by adjusting the length of the optical waveguide 160.

Next, a method in which the optical pulse generating apparatus 100 according to the embodiment of the present invention generates a pulse with a narrow pulse width, for example, a sinc pulse and the like, which can be utilized in optical time division multiplexing (OTDM), will be described.

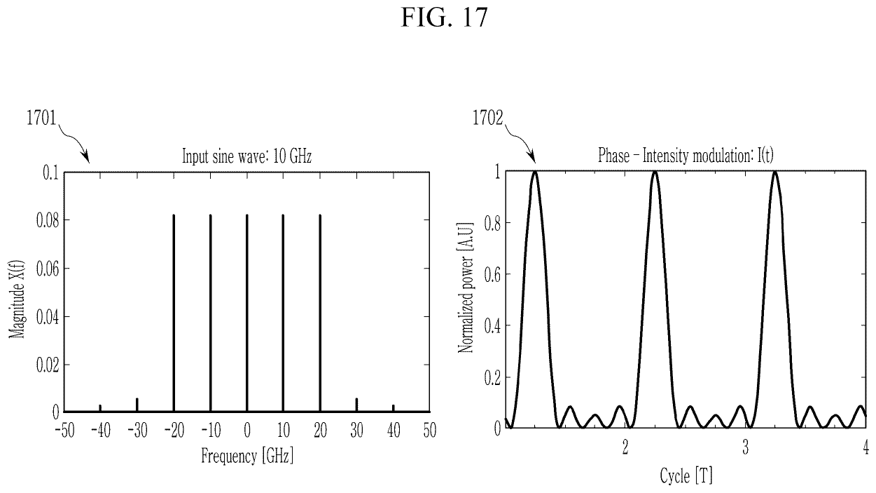

In the case of the sinc pulse, it is characterized in that the magnitudes of five harmonic components area the same in the frequency domain. Graphs expressed in the frequency domain 170) and the time domain 1702 of an ideal sinc pulse are as shown in FIG. 17. In the above, only the case where the magnitudes of five harmonic components are the same has been described, but the embodiment of the present invention is not limited thereto, and a case where the magnitudes of five or more, for example, nine harmonic components are the same may also be regarded as corresponding to a sinc pulse.

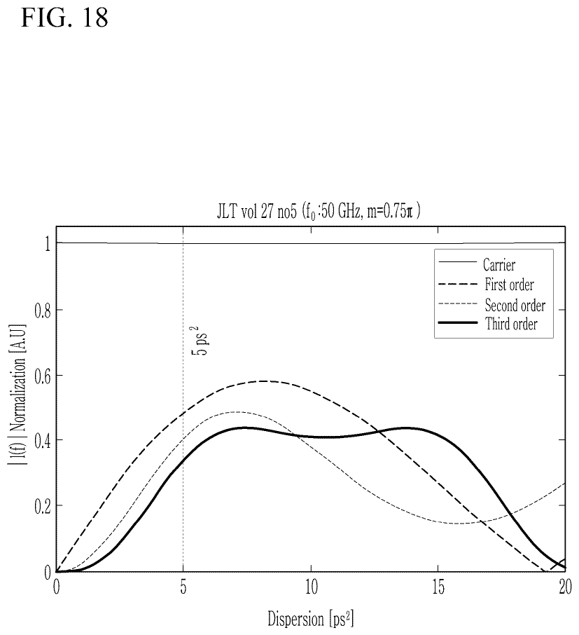

The carrier, the first-order, the second-order, and the third-order harmonic components of I(t) according to dispersion when the input sinusoidal frequency is 50 GHz and the modulation index is 075π are shown in FIG. 18.

Referring to FIG. 18, it may be seen that when the dispersion value is 5 ps², the five harmonic components are not completely similar, but the first-order, second-order, and third-order harmonic components have similar values and the difference from the carrier component is small.

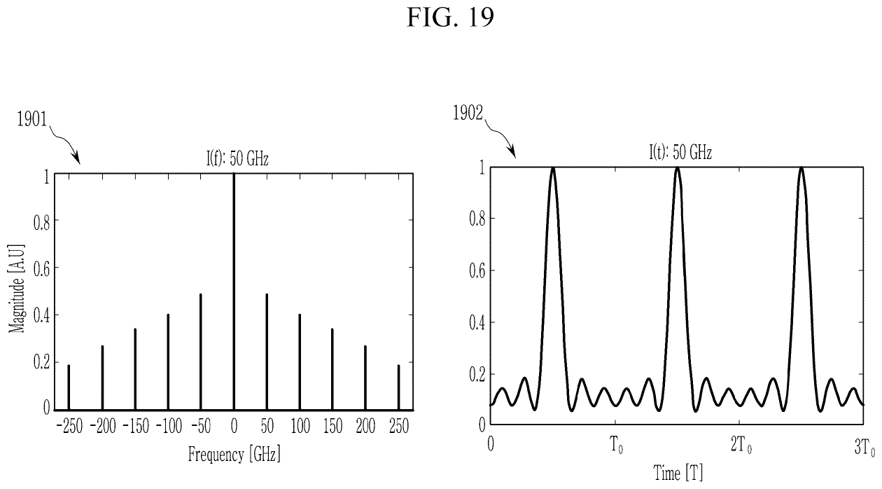

Therefore, when m=0.75π and a dispersion value of 5 ps² are applied, an I(t) aspect in the frequency domain 1901 and the time domain 1902 appears as shown in FIG. 19. Referring to FIG. 19, although the width is narrower than that of the ideal sinc pulse, it may be seen that a shape similar to the sinc pulse shown in FIG. 18 is generated since the first-order, second-order, and third-order harmonic components have similar values.

As an example, when the input sinusoidal frequency is 50 GHz, lengths according to types of optical waveguides 160 for generating the sinc pulse are as shown in the following [Table 3].

TABLE 3

| | | SiB Si | SiN |
|---|---|---|---|
| Type of optical | | (Slab: 90 nm) | 750 nm × |
| waveguide | SMF | 500 nm × 220 nm | 250 nm |
| Dispersion @1550 | 17 | 1300 | 1360 |
| nm (ps/nm/km) | | | |
| Length (m) | 23.4 | 3.02 | 2.88 |
| (sincc pulse) | | | |
| (50 GHz: 5 ps²) | | | |

The aforementioned sinc pulse corresponds to a case where an input sinusoidal frequency is 50 GHz, but sinc pulses of various shapes may be generated through dispersion value adjustment at frequencies lower or higher than this.

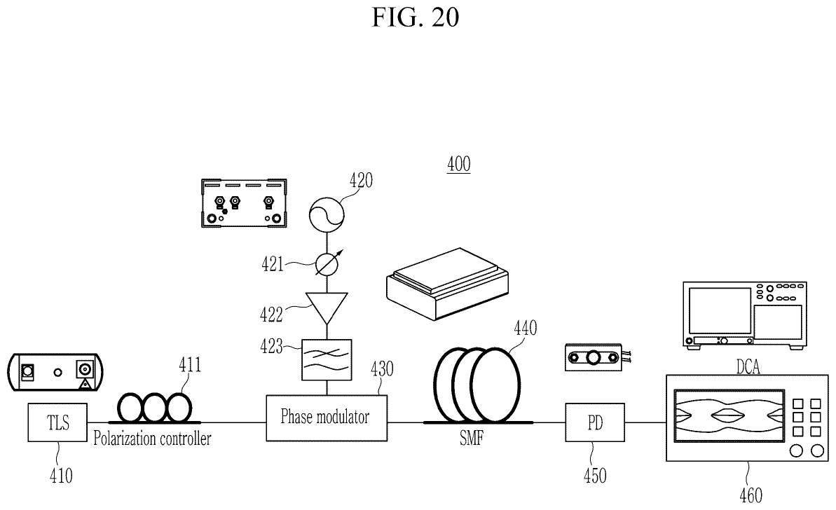

In order to confirm whether the implementation of the aforementioned sinc pulse is actually possible, an experimental setup as close as possible to the configuration shown in FIG. 1 was constructed as shown in FIG. 20.

An experiment setup configuration 400 shown in FIG. 20 includes a tunable laser source (TLS) 410 corresponding to the laser 110, the sine wave generator 120, the phase modulator 130, and the optical waveguide 160 shown in FIG. 1, respectively, a sine wave generator 420, a phase modulator 430, the SMF 440, and a photo detector PD 450 corresponding to the photo detector 230 shown in FIG. 9.

Light generated by the TLS 410 is transmitted to the phase modulator 430 through a polarization controller 411 that controls polarization, and a sine wave generated by the sine wave generator 420 is transmitted to the phase modulator 430 through an attenuator 421 that attenuates a signal, an amplifier 422 that amplifies the signal, and a low pass filter (LPF) 423 that passes only a low-band (for example, DC˜20 GHz) signal.

Using the aforementioned experimental setup configuration 400, cases were experimented where the lengths of the SMF 440, which is an optical waveguide, were 4 km and 3 km, the frequencies of the sine wave generated by the sine wave generator 420 were 10.3 GHz, 11 GHz, 12 GHz, and 13 GHz, and the modulation index was not only 0.75π but also possible up to 1.2π.

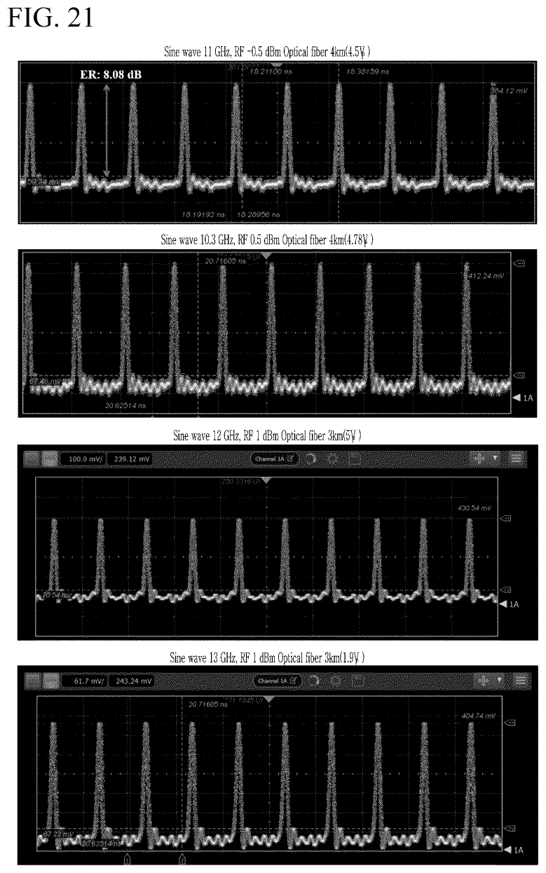

As a result of the aforementioned experiment, as shown in FIG. 21, it was confirmed that a sinc pulse with a very narrow width may be formed.

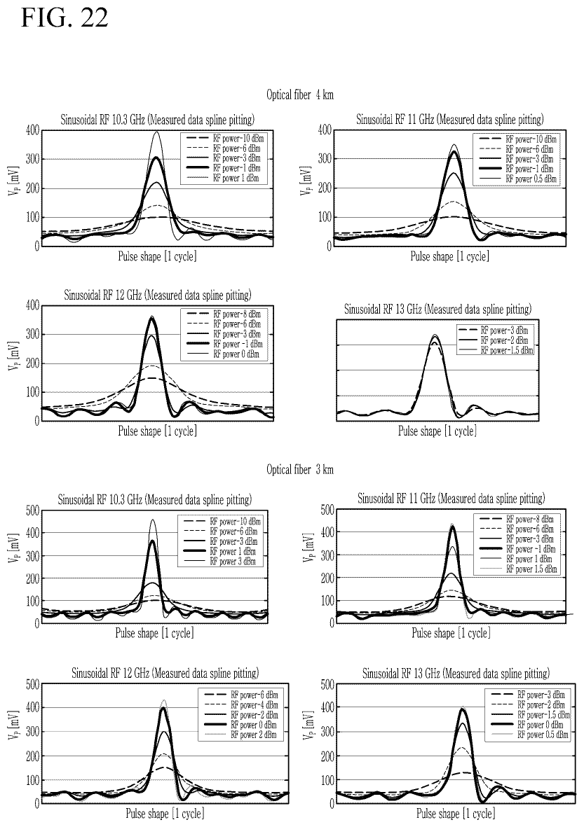

In addition, as shown in FIG. 22, although it was theoretically explained that a narrow pulse is formed when the modulation index is 0.75π, it was confirmed that a thinner pulse may be formed when a larger modulation index is applied, and it was confirmed that a modulation index up to a maximum corresponding to 1.2π is possible.

Therefore, it was confirmed that when an optical fiber appropriately corresponding to the frequency of the sine wave from about 0.75π to 1.2π is applied, a thin RZ pulse similar to the sinc pulse shape may be generated.

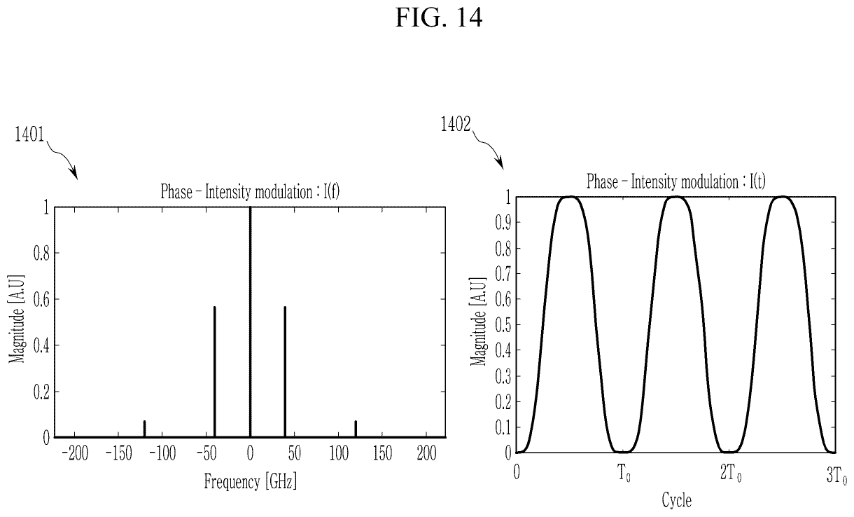

Hereinafter, an optical pulse generating method according to an embodiment of the present invention will be described. Here, the optical pulse generating method according to the embodiment of the present invention may be performed by the optical pulse generating apparatus 100 according to the embodiment of the present invention described with reference to FIG. 1 to FIG. 22.

Before the description, it is assumed and described that the types of optical pulses generated according to the optical pulse generating method according to the embodiment of the present invention and sine wave information and optical waveguide information for each corresponding optical pulse are stored in advance in, for example, the storage portion 152 of the pulse controller (150).

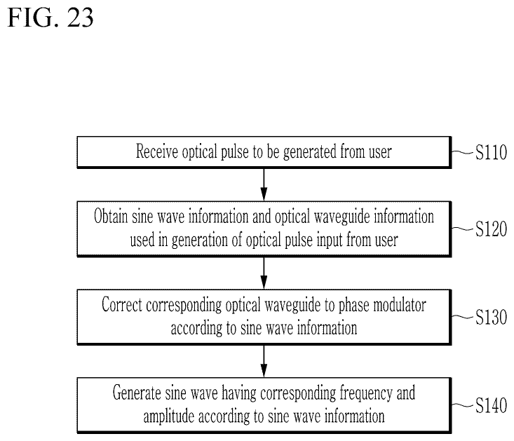

FIG. 23 is a schematic flowchart of an optical pulse generation method according to an embodiment of the present invention.

Referring to FIG. 23, first, an optical pulse to be generated is input from a user (S110). For example, the optical pulse generating apparatus 100 may display an optical pulse list including optical pulses that may be generated, for example, n-multiplied pulses such as a doubled pulse and a tripled pulse, RZ pulses such as an RZ 33% pulse, an RZ 50% pulse, and the like, or a sinc pulse and the like, to the user through the UI 151 and receive an input for an optical pulse to be generated from the user. In this case, when there are a plurality of pieces of sine wave information and corresponding optical waveguide information for generating the optical pulse input by the user, after information on these is also displayed to the user, an optical pulse corresponding to one set of sine wave information and optical waveguide information may be input.

Thereafter, sine wave information and optical waveguide information used to generate the optical pulse input from the user are obtained (S120).

Next, a corresponding optical waveguide 160 is connected to the phase modulator 130 according to the obtained optical waveguide information (length or dispersion value) (S130).

Thereafter, a sine wave having a corresponding frequency and amplitude is generated according to the obtained sine wave information (S140).

Accordingly, the since wave generated in S140 is output through the phase modulator 130 and the optical waveguide 160 connected to the phase modulator 130 in S120 such that the optical pulse input by the user in S110 may be generated.

Next, a method for the optical pulse generating apparatus 100 according to an embodiment of the present invention to calculate a length of the optical waveguide 160 for generating various pulses will be described.

First, a method for the optical pulse generating apparatus 100 according to an embodiment of the present invention to calculate the length of the optical waveguide 160 for generating an n-multiplied optical pulse will be described.

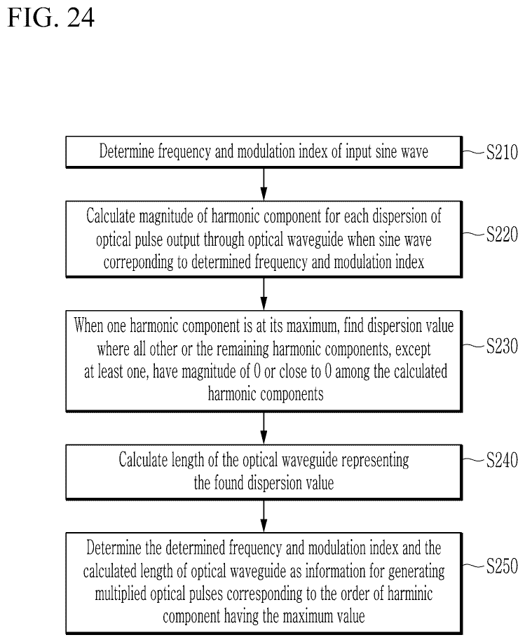

FIG. 24 is a schematic flowchart of a method for calculating a length of the optical waveguide 160 for generating an n-multiplied optical pulse in the optical pulse generating apparatus 100 according to an embodiment of the present invention.

Referring to FIG. 24, first, a frequency and a modulation index of an input sine wave are determined (S210).

Here, the frequency of the input sine wave represents a frequency of a sine wave generated by the sine wave generator 120, and the modulation index may be determined by

$$m = π \frac{A}{{V}_{π}}$$

as the amplitude of the input sine wave is determined.

Next, when a sine wave corresponding to the determined frequency and modulation index is input, the magnitude of harmonic components for each dispersion of the optical pulse output through the optical waveguide 160 of the optical pulse generating apparatus 100 is calculated (S220). Here, the magnitude of the harmonic components for each dispersion of the optical pulse output through the optical waveguide 160 may be calculated in the form of a graph. In addition, the harmonic components may be calculated from a first-order harmonic component to a fifth-order harmonic component.

Thereafter, among the calculated harmonic components, a dispersion value is found where all other harmonic components or the remaining harmonic components except at least one have a magnitude of 0 or close to 0 when one harmonic component is at its maximum (S230).

Subsequently, the length of the optical waveguide 160 representing the found dispersion value is calculated (S240). In this case, the length of the optical waveguide 160 may be calculated by a corresponding method according to the type of the optical waveguide 160.

Finally, the frequency and modulation index determined in S210 and the length of the optical waveguide 160 calculated in S240 are determined as information for generating a multiplied optical pulse corresponding to the order of the harmonic component having the maximum value in the dispersion value found in S230, for example, the first order, the second order, the third order, the fourth order, and the like (S250).

In this case, the optical pulse generating apparatus 100 according to the embodiment of the present invention may generate a corresponding n-multiplied optical pulse according to the information determined in S250.

Next, a method for the optical pulse generating apparatus 100 according to the embodiment of the present invention to calculate the length of the optical waveguide 160 for generating an RZ pulse will be described.

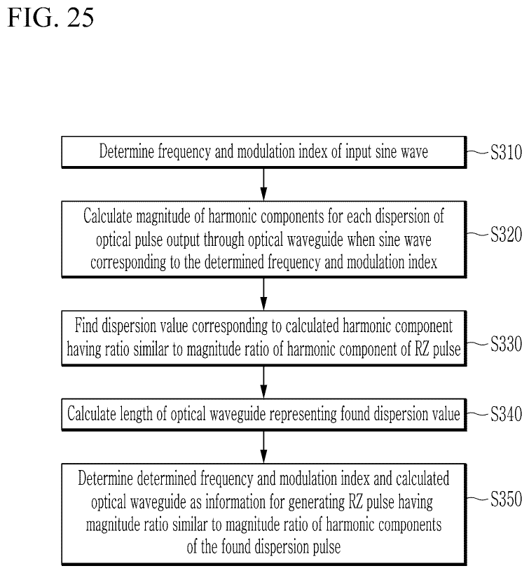

FIG. 25 is a schematic flowchart of a method for calculating a length of the optical waveguide 160 for generating an RZ pulse in the optical pulse generating apparatus according to an embodiment of the present invention.

Referring to FIG. 25, first, a frequency and a modulation index of an input sine wave are determined (S310).

Here, the frequency of the input wave represents the frequency of the sine wave generated by the sine wave generator 120, and the modulation index may be determined by

$$m = π \frac{A}{{V}_{π}}$$

as the amplitude of the input sine wave is determined.

Next, when a sine wave corresponding to the determined frequency and modulation index is input, the magnitude of harmonic components for each dispersion of the optical pulse output through the optical waveguide 160 of the optical pulse generating apparatus 100 is calculated (S320). Here, the magnitude of the harmonic components for each dispersion of the optical pulse output through the optical waveguide 160 may be calculated in the form of a graph. In addition, the harmonic components may be calculated from a first order harmonic component to a fifth order harmonic component.

Thereafter, among the magnitude ratios of the calculated harmonic components, a dispersion value corresponding to the calculated harmonic components having a ratio similar to the magnitude ratio of the harmonic components of the RZ pulse is found (S330).

Subsequently, a length of the optical waveguide 160 representing the found dispersion value is calculated (S340). In this case, the length of the optical waveguide 160 may be calculated by a corresponding method according to the type of the optical waveguide 160.

Finally, the frequency and modulation index determined in S310 and the length of the optical waveguide 160 calculated in s340 are determined as information for generating an RZ pulse having a magnitude ratio similar to the magnitude ratio of the harmonic components of the dispersion value found in S330.

In this case, the optical pulse generating apparatus 100 according to the embodiment of the present invention may generate a corresponding RZ pulse according to the information determined in S350.

Meanwhile, in S330, when the type of the RZ pulse is an 50% pulse, the dispersion value is found using the magnitude ratio of the carrier and the first-order harmonic component.

However, in S330, when the type of the RZ pulse is an RZ 33% pulse, the dispersion value is found using the magnitude ratios of each of the second-order harmonic component and the fourth-order harmonic component relative to the carrier.

In this way, according to the embodiment of the present invention, n-multiplied optical pulses, RZ pulses, and sinc pulses may be generated using a simple structure.

In addition, a high-frequency optical pulse close to 150 GHz may be generated.

Next, a method for the optical pulse generating apparatus 100 according to an embodiment of the present invention to calculate a length of the optical waveguide 160 for generating a sinc pulse that can be used in ORDM will be described.

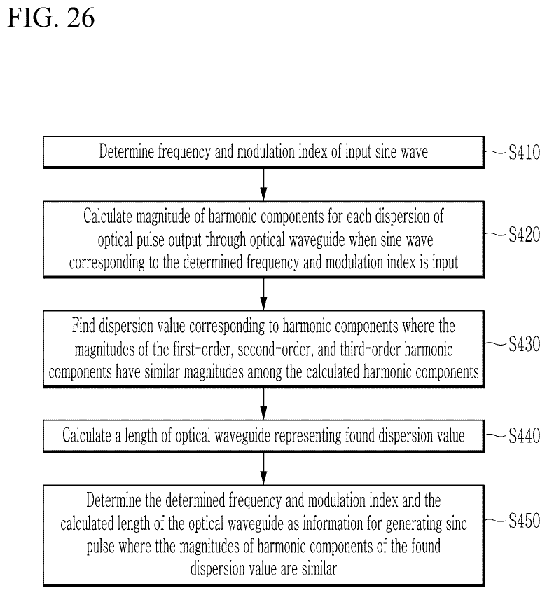

FIG. 26 is a schematic flowchart of a method for calculating a length of the optical waveguide 160 for generating an sinc pulse in the optical pulse generating apparatus according to an embodiment of the present invention.

Referring to FIG. 26, first, a frequency and a modulation index of an input sine wave are determined (S410).

Here, the frequency of the input sine wave represents a frequency of a sine wave generated by the sine wave generator 120, and the modulation index may be determined by

$$m = π \frac{A}{{V}_{π}}$$

as the amplitude of the input sine wave is determined.

Next, when a sine wave corresponding to the determined frequency and modulation index is input, the magnitude of harmonic components for each dispersion of the optical pulse output through the optical waveguide 160 of the optical pulse generating apparatus 100 is calculated (S420). Here, the magnitude of the harmonic components for each dispersion of the optical pulse output through the optical waveguide 160 may be calculated in the form of a graph. In addition, the harmonic components may be calculated from a first-order harmonic component to a fifth-order harmonic component.

Thereafter, among the calculated harmonic components, a dispersion value corresponding to harmonic components where the magnitudes of the first-order, second-order, and third-order harmonic components have similar magnitudes is found (S430). Here, that the magnitudes of the first-order, the second-order, and the third-order harmonic components are similar indicates that a difference in magnitudes of the three harmonic components is within a predetermined threshold, and such a threshold may be set by theoretical calculation or statistics through multiple measurements.

Subsequently, a length of the optical waveguide 160 representing the found dispersion value is calculated (S440). In this case, the length of the optical waveguide 160 may be calculated by a corresponding method according to the type of the optical waveguide 160.

Finally, the frequency and modulation index determined in S410 and the length of the optical waveguide 160 calculated in S440 are determined as information for generating a sinc pulse where the magnitudes of harmonic components of the dispersion value found in S430 are similar (S450).

In this way, the optical pulse generating apparatus 100 according to the embodiment of the present invention may generate a corresponding sinc pulse according to the information determined in S450.

The embodiments of the present disclosure described above are not only implemented through an apparatus and a method, but may also be implemented through a program realizing functions corresponding to the configurations of the embodiments of the present disclosure or a recording medium in which the program is recorded.

Although the embodiments of the present disclosure have been described in detail above, the scope of rights of the present disclosure is not limited thereto, and various modifications and improvements by those skilled in the art using the basic concept of the present disclosure defined in the following claims also fall within the scope of rights of the present disclosure.

What is claimed is:

1. An optical pulse generating apparatus comprising:
a sine wave generator that generates one of a plurality of sine waves;
a phase modulator that performs modulation for incident light from a laser using the sine wave generated by the sine wave generator;
an optical waveguide connector that connects an optical waveguide to the phase modulator—when the number of optical waveguides is two or more, one of two or more optical waveguides is selected and connected to the phase modulator; and
a pulse controller that generates the one sine wave by transmitting sine wave information, used in generation of an optical pulse selected by a user, to the sine wave generator, and transmits optical waveguide information used in generation of the optical pulse to the optical waveguide connector to select the optical waveguide connected to the phase modulator,
wherein the sine wave information includes frequency information and amplitude information (or modulation index information) for generation of the optical pulse, and the optical waveguide information includes length information (or dispersion value information) for generation of the optical pulse.

2. The optical pulse generating apparatus of claim 1, wherein:
the pulse controller comprises:
a storage portion that stores sine wave information and optical waveguide information corresponding to each optical pulse;
a selection controller that obtains sine wave information and optical waveguide information corresponding to an optical pulse selected by a user input through a user interface from the storage portion;
a sine wave controller that controls the sine wave generator to generate a sine wave corresponding to the sine wave information obtained by the selection controller; and
an optical waveguide controller that controls the optical waveguide connector to select an optical waveguide corresponding to the optical waveguide information obtained by the selection controller.

3. The optical pulse generating apparatus of claim 1, wherein:
when the optical pulse selected by the user is an n-multiplied pulse (n is a natural number from 1 to 5), the optical waveguide information is determined as a dispersion value when a specific order harmonic component among 0-th order harmonic component to fifth-order harmonic component of the optical pulse output through the optical waveguide connected to the phase modulator according to the sine wave information is at a maximum, and all the remaining harmonic components or all remaining harmonic components except al least one is 0, and
the n-multiplied pulse is a multiplied pulse of the specific order.

4. The optical pulse generating apparatus of claim 3, wherein:
when the optical pulse selected by the user is a tripled pulse, the optical waveguide information is determined as a dispersion value when the magnitude of a third-order harmonic component of an optical pulse output through the optical waveguide becomes at its maximum and the magnitudes of first-order harmonic component, second-order harmonic component, and fourth-order harmonic component of the optical pulse are zero.

5. The optical pulse generating apparatus of claim 4, wherein:
when the optical pulse selected by the user is a tripled pulse, a low pass filter is used to remove a fifth-order harmonic component of the optical pulse output through the optical waveguide from the determined dispersion value.

6. The optical pulse generating apparatus of claim 1, wherein:
when the optical pulse selected by the user is a return to zero (RZ) pulse, the optical waveguide information is determined as a dispersion value of a case in which a magnitude ratio of a carrier of an optical pulse output through an optical waveguide connected to the phase modulator according to the sine wave information and a first-order harmonic component is similar to a magnitude ratio of a carrier and a first-order harmonic component of an RZ 50% pulse within a predetermined difference range, and
the RZ pulse is an RZ 50% pulse.

7. The optical pulse generating apparatus of claim 1, wherein:
when the optical pulse selected by the user is a return to zero (RZ) pulse, the optical waveguide information is determined as a dispersion value of a case in which magnitude ratios of a carrier, a second-order harmonic component, and a fourth-order harmonic component of an optical pulse output through an optical waveguide connected to the phase modulator according to the sine wave information is similar to magnitude ratios of a carrier, a second-order harmonic component, and a fourth-order harmonic component of an RZ 33% pulse is within a predetermined difference range, and
the RZ pulse is an RZ 33% pulse.

8. The optical pulse generating apparatus of claim 1, wherein:
when the optical pulse selected by the user is a sinc pulse of which a pulse width is narrow to be usable in an optical time division multiplexing (OTDM), the optical waveguide information is determined as a dispersion value of a case in which the magnitude of each of a first-order harmonic component, a second-order harmonic component, and a third-order harmonic component of an optical pulse output through an optical waveguide connected to the phase modulator according to the sine wave information is similar within a predetermined difference range.

9. The optical pulse generating apparatus of claim 1, wherein:
even though a frequency of the sine wave is the same, a length of the optical waveguide changes depending on the amplitude of the sine wave, and
even though the amplitude of the sine wave is the same, the length of the optical waveguide changes depending on the frequency of the sine wave.

10. The optical pulse generating apparatus of claim 1, wherein:
the phase modulator is a lithium niobate (LiNbO₃) modulator.

11. The optical pulse generating apparatus of claim 1, wherein:
the optical waveguide is a silicon optical waveguide implemented in a silicon photonics chip together with the optical waveguide connector.

12. The optical pulse generating apparatus of claim 11, wherein:
the phase modulator is a silicon phase modulator implemented in the silicon photonics chip and connected to the optical waveguide connector.

13. A method for an optical pulse generating apparatus to generate an optical pulse,
wherein the optical pulse generating apparatus comprises a phase modulator that performs modulation on incident light from a laser using a sine wave and outputs the modulated light through an optical waveguide,
the method comprises:
receiving an optical pulse selected to be generated from a user;
obtaining sine wave information and optical waveguide information used in generation of the optical pulse selected by the user among a plurality of pieces of predetermined sine wave information and a plurality of pieces of predetermined optical waveguide information;
connecting an optical waveguide corresponding to the optical waveguide information among at least one of optical waveguides to the phase modulator; and
generating a corresponding sine wave according to the obtained sine wave information and providing the sine wave to the phase modulator, and
the sine wave information includes frequency information and amplitude information (or modulation index information) for generation of the optical pulse, and the optical waveguide information includes length information (or dispersion value information) of an optical waveguide for generation of the optical pulse.

14. The method of claim 13, wherein:
when the optical pulse selected by the user is an n-multiplied pulse (n is a natural number from 1 to 5), the optical waveguide information is determined as a dispersion value when a specific order harmonic component among 0-th order harmonic component to fifth-order harmonic component of the optical pulse output through the optical waveguide connected to the phase modulator according to the sine wave information is at a maximum, and all the remaining harmonic components or all remaining harmonic components except at least one is 0, and
the n-multiplied pulse is a multiplied pulse of the specific order.

15. The method of claim 14, wherein:
when the optical pulse selected by the user is a tripled pulse, the optical waveguide information is determined as a dispersion value when the magnitude of a third-order harmonic component of an optical pulse output through the optical waveguide becomes at a maximum and the magnitudes of first-order harmonic component, second-order harmonic component, and fourth-order harmonic component of the optical pulse are zero.

16. The method of claim 15, wherein:
when the optical pulse selected by the user is a tripled pulse, a low pass filter is used to remove a fifth-order harmonic component of the optical pulse output through the optical waveguide from the determined dispersion value.

17. The method of claim 13, wherein:
when the optical pulse selected by the user is a return to zero (RZ) pulse, the optical waveguide information is determined as a dispersion value of a case in which a magnitude ratio of a carrier of an optical pulse output through an optical waveguide connected to the phase modulator according to the sine wave information and a first-order harmonic component is similar to a magnitude ratio of a carrier and a first-order harmonic component of an RZ 50% pulse within a predetermined difference range, and
the RZ pulse is an RZ 50% pulse.

18. The method of claim 13, wherein:
when the optical pulse selected by the user is a return to zero (RZ) pulse, the optical waveguide information is determined as a dispersion value of a case in which magnitude ratios of a carrier, a second-order harmonic component, and a fourth-order harmonic component of an optical pulse output through an optical waveguide connected to the phase modulator according to the sine wave information is similar to magnitude ratios of a carrier, a second-order harmonic component, and a fourth-order harmonic component of an RZ 33% pulse is within a predetermined difference range, and,
the RZ pulse is an RZ 33% pulse.

19. The method of claim 13, wherein:
when the optical pulse selected by the user is a sinc pulse of which a pulse width is narrow to be usable in an optical time division multiplexing (OTDM), the optical waveguide information is determined as a dispersion value of a case in which the magnitude of each of a first-order harmonic component, a second-order harmonic component, and a third-order harmonic component of an optical pulse output through an optical waveguide connected to the phase modulator according to the sine wave information is similar within a predetermined difference range.

20. The method of claim 13, wherein:
the phase modulator is a lithium niobate (LiNbO₃) modulator, and
the optical waveguide is a silicon optical waveguide implemented in a silicon photonics chip together with the optical waveguide connector.

21. The method of claim 13, wherein:
the phase modulator is a silicon phase modulator, and
the phase modulator is implemented in a silicon photonics chip together with the optical waveguide connector and the optical waveguide.
